(19) United States
(12) Patent Application Publication
(10) Pub. No.: US 2014/0240483 A1
(43) Pub. Date: Aug. 28, 2014

(54) SMART PHOTOGRAPHING APPARATUS

(71) Applicant: National Quemoy University, Kinmen County (TW)

(72) Inventor: Chin-Tan LEE, Kinmen County (TW)

(73) Assignee: National Quemoy University, Kinmen County (TW)

(21) Appl. No.: 14/188,856

(22) Filed: Feb. 25, 2014

(30) Foreign Application Priority Data
Feb. 26, 2013 (TW) 102106776

(51) Int. Cl. H04N 7/18

(52) U.S. Cl. CPC H04N 7/18
USPC 348/78

(57) ABSTRACT

The present invention discloses a smart photographing apparatus, comprising a casing, a first photographing module, a second photographing module, and a control module. The first photographing module comprises a sensing lens installed on one side of the casing to capture eye motion images when a photographer is blinking. The second photographing module comprises a photographing lens installed on the other side of the casing to execute an image capturing function of shooting an image of a target. The control module is connected to the first photographing module and the second photographing module, and the control module generates an image capturing instruction upon receiving the eye motion images and controls the second photographing module to execute the image capturing function according to the image capturing instruction.

### CROSS-REFERENCE TO RELATED APPLICATION

This application claims priority from Taiwan Patent Application No. 102106776, filed on Feb. 26. 2013 in Taiwan Intellectual Property Office, the contents of which are hereby incorporated by reference in their entirety.

### BACKGROUND OF THE INVENTION

1. Field of the Invention

The present invention is related to a smart photographing apparatus, and particularly to a smart photographing apparatus which uses an eye blinking motion rather than a shutter button to perform a picture shooting.

2. Description of the Related Art

With the advance of science and technology, new photographing products appear one after another. Moreover, image processing technology has become more and more mature. The progress of photographing apparatus includes not only the improvement of appearance, but also the hardware and software functions, especially in image processing, pictorial visual calibration, focusing, and zooming, etc. Currently, the professional photographing apparatuses already possess powerful picture processing ability, even for smart mobile phones with photographing functions can also achieve rather brilliant imaging and processing performances.

In current average cameras, no matter a single-lens reflex (SLR), a SLR_Like, or a smart mobile phone, a shutter press button is still utilized to shoot a picture. Some of the intelligent shooting functions focus on the person under shooting, for example, a camera can perform image capturing immediately when the person under shooting is smiling. Even though cameras are designed to capture the image of a target, the handling of a picture shooting is mainly controlled by the photographer. Even though cameras are designed to capture the image of a target, the handling of a picture shooting should be mainly controlled by the photographer. However, there is hardly any camera with smart shooting functions developed particularly for the photographer presently. Therefore, a photographer still pushes a shutter button to shoot a picture.

Therefore, the purpose of the present invention is to develop a photographing apparatus to improve the above problem.

### SUMMARY OF THE INVENTION

According to the problem of prior arts, the purpose of the present invention is to provide a smart photographing apparatus to solve the problem that photographers merely use a shutter button of traditional cameras to shoot a picture.

Based on the purpose of the present invention, a smart photographing apparatus is disclosed. The smart photographing apparatus comprises a casing, a first photographing module, a second photographing module, and a control module. The first photographing module comprises a sensing lens installed on one side of the casing to capture eye motion images when a photographer is blinking. The second photographing module comprises a photographing lens installed on the other side of the casing to execute an image capturing function of shooting an image of a target. The control module is connected to the first photographing module and the second photographing module, and the control module generates an image capturing instruction upon receiving the eye motion images and controls the second photographing module to execute the image capturing function according to the image capturing instruction.

Furthermore, the first photographing module captures a plurality of sets of the eye motion images when the photographer is continuously blinking, and the control module generates the continuous image capturing instructions based on the plurality of sets of the eye motion images to control the second photographing module to perform the continuous image capturing.

Furthermore, the second photographing module performs a focusing function before executing the image capturing function, and the control module begins to generate the image capturing instruction based on the eye motion images after the focusing function is accomplished.

Furthermore, the focusing function is automatically executed when the second photographing module is initialized.

The smart photographing apparatus of the present invention further comprises an input module which is connected to the control module, and the control module generates the image capturing instruction or controls the second photographing module to execute the focusing function based on an input signal when the input module receives the input signal.

As mentioned above, the smart photographing apparatus of the present invention is installed with dual lenses, and one lens is use to shoot an external image while the other lens is used to sense the eye motion of the photographer. When a photographer is blinking his or her eye, the smart photographing apparatus of the present invention will execute the image capturing and does not need to press the shutter button. Therefore, it is rather novel, innovative, and practical in use.

### BRIEF DESCRIPTION OF THE DRAWINGS

FIG. 1 is a block diagram showing a smart photographing apparatus according to a preferred embodiment of the present invention.

FIG. 2 is a flow chart showing the steps of method of capturing image by using the smart photographing apparatus according to the preferred embodiment of the present invention.

FIG. 3 is a diagram showing the preferred embodiment of the smart photographing apparatus of the present invention.

### DETAILED DESCRIPTION OF THE PREFERRED EMBODIMENTS

To illustrate the characteristics, content, and advantage of the present invention and the effects it can fulfill, a preferred embodiment and the corresponding drawings and provided to offer more detailed descriptions. The purpose of the drawings being used is for illustration and to assist the specifications, they are not necessarily the real proportion and precise allocations of the embodiments of the present invention. Thus, they should not be used to limit the privilege coverage of the practical embodiments of the present invention.

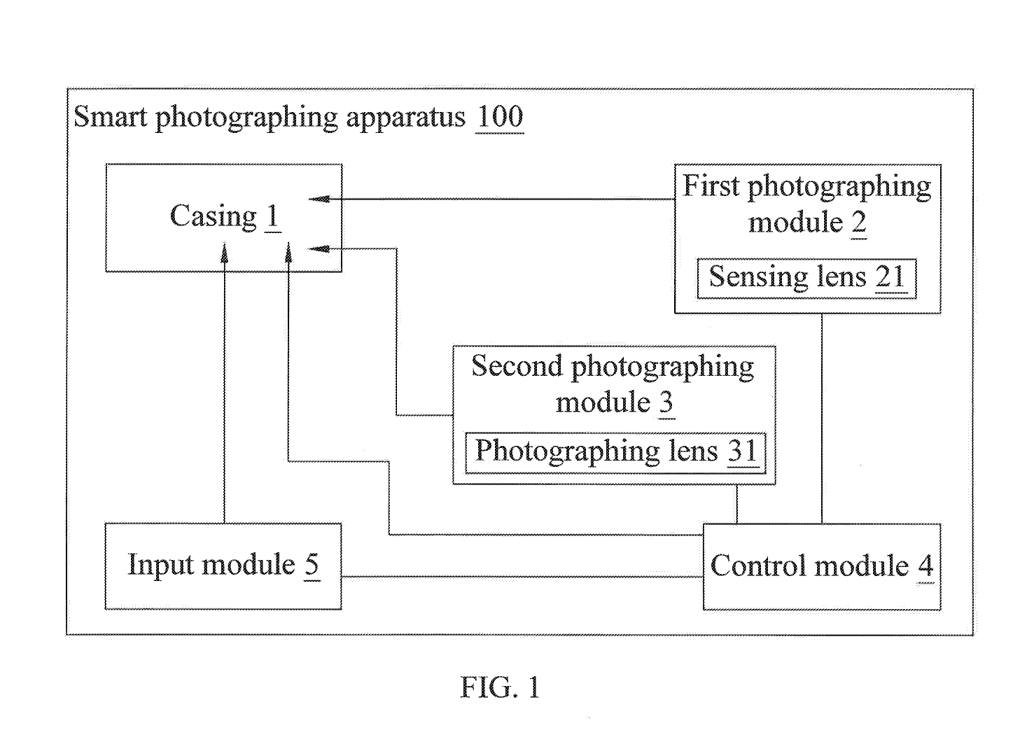

Referring to FIG. 1, FIG. 1 is a block diagram showing a smart photographing apparatus according to a preferred embodiment of the present invention. In FIG. 1, the smart photographing apparatus 100 can be any kind and model of cameras, for example, a single-lens reflex (SLR), a SLR_Like, an ordinary digital camera, or a smart mobile phone with a camera, etc. The smart photographing apparatus 100 comprises a casing 1, a first photographing module 2, a second photographing module 3, a control module 4, and an input module 5. The control module 4 is electrically connected to the first photographing module 2, the second photographing module 3, and the input module 5. The first photographing module 2, the second photographing module 3, and the control module 4, and the input module 5 are all installed within the casing 1. Moreover, the first photographing module 2 comprises a sensing lens 21 which is installed on one side of the casing 1, and the second photographing module 3 comprises a photographing lens 31 which is installed on the other side of the casing 1 and opposite to the side where the sensing lens 21 is installed. The sensing lens 21 is used to sense the eye motion of a photographer, and the photographing lens 31 is used to shoot an image of a target. Except for their respective cameras, the first photographing module 2 and the second photographing module 3 further comprise image sensing devices, etc. The control module 4 can be a control chip, and the input module 5 can be a button, for example, a shutter button, etc.

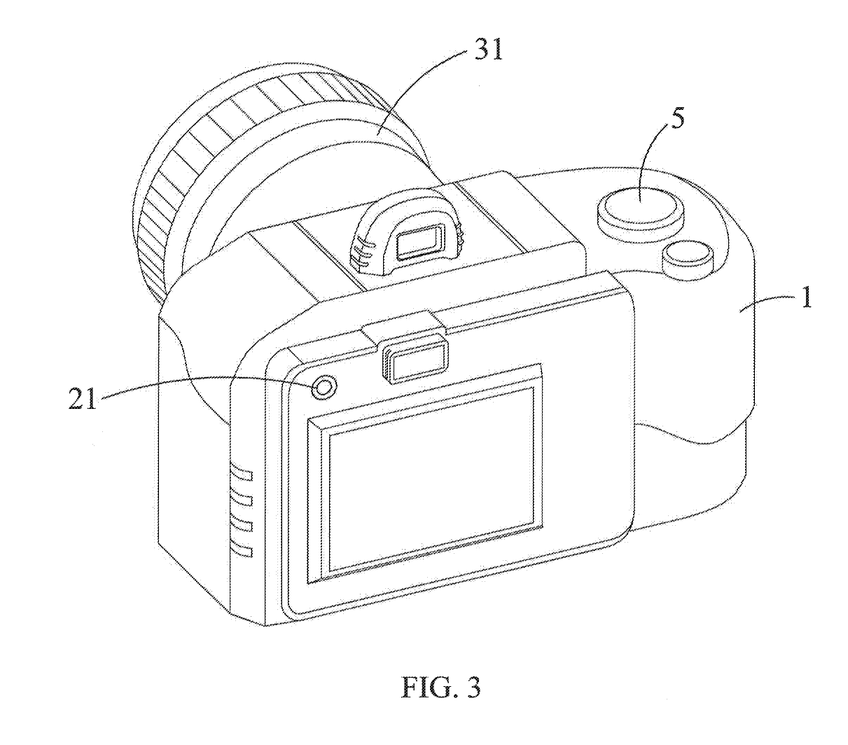

Please refer to FIG. 1 and FIG. 3, FIG. 3 is a diagram showing the preferred embodiment of the smart photographing apparatus of the present invention. As mentioned in the above embodiment, the sensing lens 21 and the photographing lens 31 are installed opposite to each other. When a photographer wants to use the smart photographing apparatus 100 of the present invention to shoot a picture, he or she can turn on the smart photographing apparatus 100 and initialize the second photographing module 3 such that the second photographing module 3 can perform the focusing function automatically, or the photographer can input an input signal to the input module 5 such that the control module 4 can control the second photographing module 3 to execute the focusing function according to the input signal. After the second photographing module finishes the focusing function, the photographer can use the first photographing module 2 to shoot a picture. At this moment the photographer can blink toward the sensing lens 21 to allow the first photographing module 2 to acquire a plurality of eye motion images when the photographer is blinking, then the control module 4 generates an image capturing instruction upon receiving the plurality of eye motion image and transmits the image capturing instruction to the second photographing module 3. The second photographing module 3 will execute the image capturing function to shoot a picture of a target according to the image capturing instruction. In this manner, the photographer can shoot a picture without pressing a shutter button. Certainly, the photographer can also input an input signal via the input module 5 of a shutter button. Based on the input signal, the control module 4 controls the second photographing module 3 to execute the image capturing function.

In the above, the photographer can also achieve continuous shooting via the first photographing module 2. The photographer can blink continuously toward the sensing lens 21 of the first photographing module 2 to enable the first photographing module 2 to capture a plurality of eye motion images. Afterward, the control module 4 generates the continuous image capturing instructions based on the plurality of sets of the eye motion images to control the second photographing module to perform the continuous image capturing.

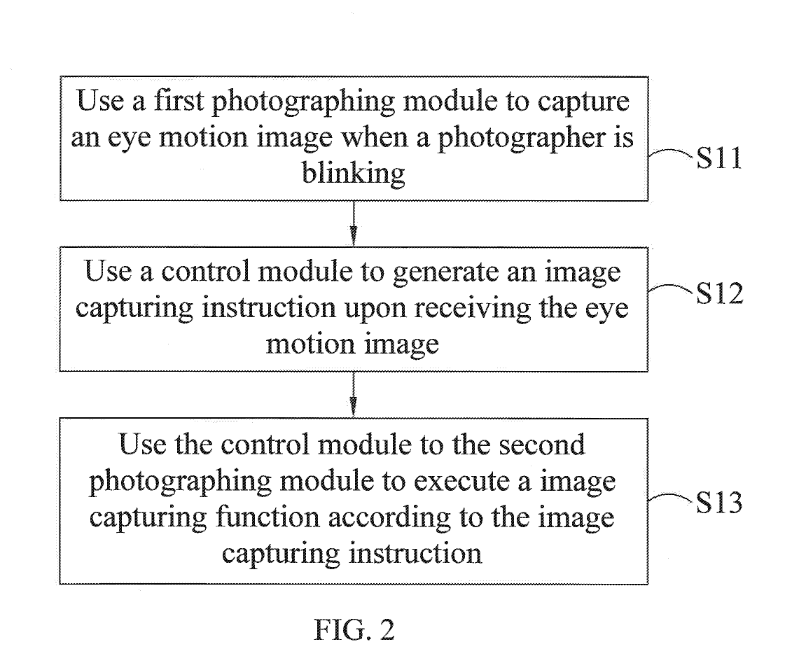

Please refer to FIG. 2; FIG. 2 is a flow chart showing steps of method of capturing image by using the smart photographing apparatus according to the preferred embodiment of the present invention. The flow steps comprise the steps.

In Step S11, a first photographing module is Used to capture an eye motion image when a photographer is blinking.

In Step S12, a control module is used to generate an image capturing instruction upon receiving the eye motion image.

In Step S13, the control module is used to the second photographing module to execute a image capturing function according to the image capturing instruction.

In summation, the eye blinking of the photographer is been utilized in the smart photographing apparatus of the present invention to execute the function of a picture shooting. Compared with the prior arts of merely using the shutter button to perform a picture shooting, the present invention is more practical and convenient.

In summary, it is clear that the present invention has broken through the technical limitation of the prior arts and achieved the desired improvements. Moreover, the present invention is not easy to be conceived by those who skilled in this technical area. Apparently, the novelty and practicability of the present invention have met the application requirements of a patent.

The aforementioned preferred embodiment is to explain the technical ideas and features of the present invention. The purpose is to enable those who skilled in this technical area to understand the content of the present invention and realize it. It will be understood that the present invention is not limited to the details thereof. Various equivalent variations and modifications may still occur to those skilled in this art in view of the teachings of the present invention. Thus, all such variations and equivalent modifications are also embraced with the scope of the present invention as defined in the appended claim.

What is claimed is:

1. A smart photographing apparatus, comprising:
a casing;
a first photographing module, comprising a sensing lens installed on one side of the casing to capture eye motion images when a photographer is blinking;
a second photographing module, comprising a photographing lens installed on the other side of the casing to execute an image capturing function of shooting an image of a target; and
a control module, connected to e first photographing module and the second photographing module, wherein the control module generates an image capturing instruction upon receiving the eye motion images, and controls the second photographing module to execute the image capturing function according to the image capturing instruction.

2. The smart photographing apparatus of claim 1, wherein the first photographing module captures a plurality of sets of the eye motion images when the photographer is continuously blinking, and the control module generates the continuous image capturing instructions based on the plurality of sets of the eye motion images to control the second photographing module to perform the continuous image capturing.

3. The smart photographing apparatus of claim 1, wherein the second photographing module performs a focusing function before executing the image capturing function, and the control module begins to generate the image capturing instruction based on the eye motion images after the focusing function is accomplished.

4. The smart photographing apparatus of claim 3, wherein the focusing function is automatically executed when the second photographing module is initialized.

5. The smart photographing apparatus of claim 3, further comprising an input module which is connected to the control module, wherein the control module generates the image capturing instruction or controls the second photographing module to execute the focusing function based on an input signal when the input module receives the input signal.
